(19) United States
(12) Patent Application Publication
(10) Pub. No.: US 2014/0252260 A1
(43) Pub. Date: Sep. 11, 2014

(54) Plug Valve Actuator Stem

(71) Applicant: J-Mac Tool, Inc., Fort Worth, TX (US)

(72) Inventor: Ross Woods, Arlington, TX (US)

(73) Assignee: J-Mac Tool, Inc., Fort Worth, TX (US)

(21) Appl. No.: 14/199,598

(22) Filed: Mar. 6, 2014

Related U.S. Application Data
(60) Provisional application No. 61/773,637, filed on Mar. 6, 2013.

(51) Int. Cl. F16K 5/04

(52) U.S. Cl. CPC F16K 5/0442
USPC 251/309

(57) ABSTRACT

An actuator stem assembly configured to provide bi-directional movement of a stem in relation to a plug to isolate external forces exerted upon the stem from misaligning the plug. The actuator stem assembly includes a stem, an intermediate slider, and a plug. The stem is configured to slidingly engage the intermediate slider in a manner sufficient to allow translation in a first direction. The intermediate slider is configured to slidingly engage the plug to allow translation of the intermediate slider in a second direction. The first and the second directions are perpendicular to one another, thereby allowing for bi-directional movement of the stem.

### BACKGROUND

1. Field of the Invention

The application relates generally to plug valves and, more particularly, to an assembly to prevent misaligning of the plug valve.

2. Description of Related Art

It is difficult to economically produce hydrocarbons from low permeability reservoir rocks. Oil and gas production rates are often boosted by hydraulic fracturing, a technique that increases rock permeability by opening channels through which hydrocarbons can flow to recovery wells. During hydraulic fracturing, a fluid is pumped into the earth under high pressure (sometimes as high as 50,000 PSI) where it enters a reservoir rock and cracks or fractures it. When the pressure is released, the fractures partially close on the proppants, leaving channels for oil and gas to flow.

Typical sites may use one or more trucks holding specialized pumps for delivering fracture fluids at sufficiently high rates and pressures to complete a hydraulic fracturing procedure or “frac job.” These trucks are in fluid communication with the well through the use of tubing. To facilitate safety and servicing, a shut-off valve, or plug valve, is located at selected locations in the tubing. An operator is able to rotate a plug in the plug valve to seal off an upstream end from a downstream end.

Conventional plug valves generate a seal for low and high pressure loads. The seal is generated typically by metal to metal contact between the plug and portions of the plug valve housing. In order to operate a plug valve, an operator typically exerts a torque about a stem attached to the plug. The stem is typically either integral with the plug or aligned so as to provide limited slip in a single direction. As the plug is rotated relative to the plug housing, fluid pressures exert a force against the plug that can cause axial misalignment of the plug relative to the plug valve housing. Additionally, external forces transferred to the plug through the stem may also cause axial misalignment. When misaligned in the plug valve housing, plugs fail to seal and become susceptible to premature wear and premature maintenance.

Although great strides have been made in plug valves, considerable shortcomings remain.

### DESCRIPTION OF THE DRAWINGS

The novel features believed characteristic of the invention are set forth in the description. However, the invention itself, as well as a preferred mode of use, and further objectives and advantages thereof, will best be understood by reference to the following detailed description when read in conjunction with the accompanying drawings, wherein:

FIG. 1 is a perspective view of a plug valve having an actuator stem assembly according to the preferred embodiment of the present application;

FIG. 2 is a top view of the plug valve assembly of FIG. 1;

FIG. 3 is an end view of the plug valve assembly of FIG. 1;

FIG. 4 is a side view of the plug valve assembly of FIG. 1;

FIG. 5 is a section view of the plug valve assembly of FIG. 4 taken along the line V-V;

FIG. 6 is an exploded view of the actuator stem assembly of FIG. 1; and

FIG. 7 is a partial exploded view of the actuator stem assembly of FIG. 6.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

An illustrative embodiment of the invention is described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

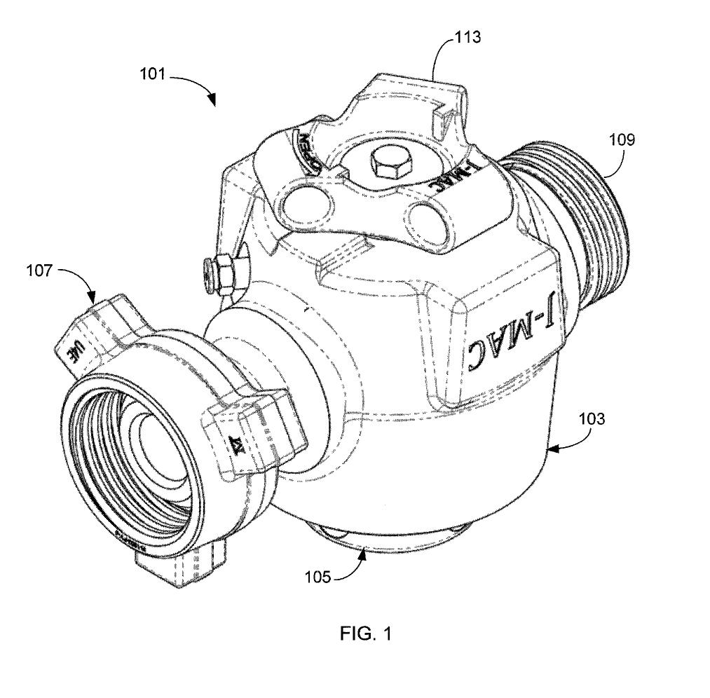

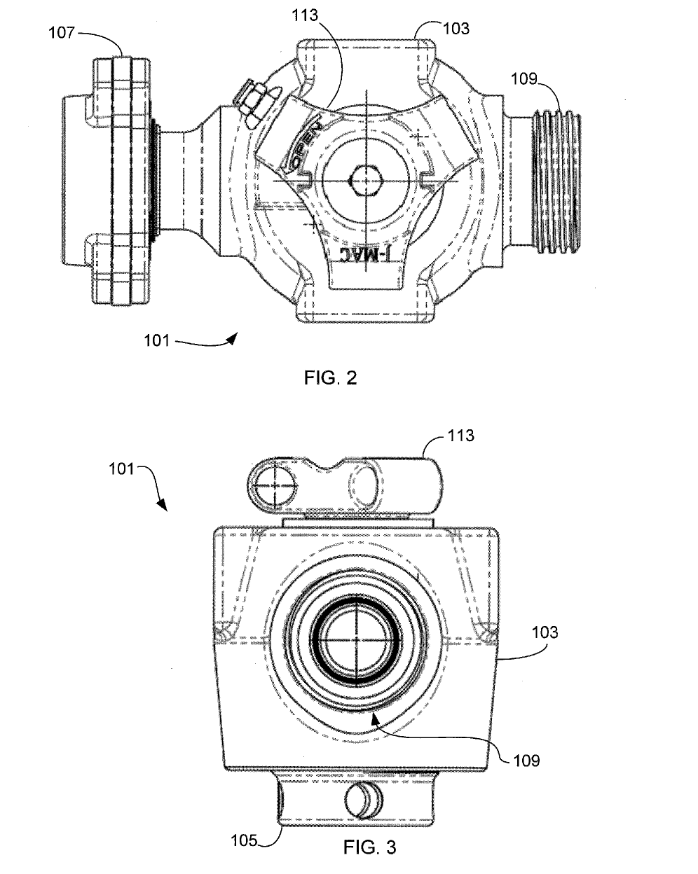

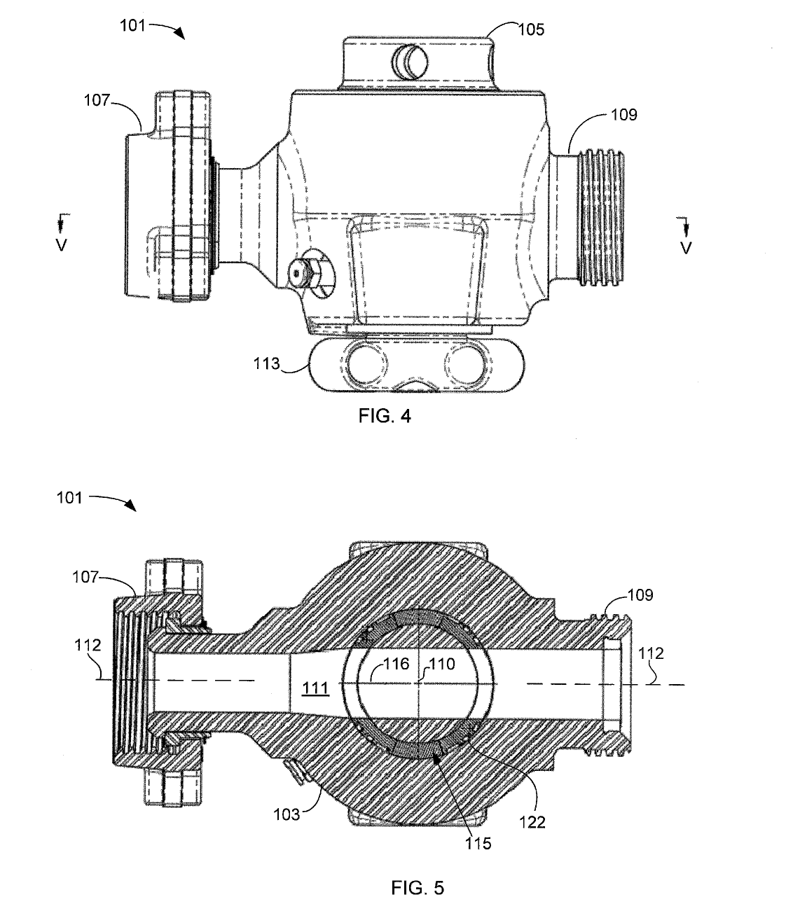

Referring to FIGS. 1-5 in the drawings, a plug valve assembly is illustrated. Plug valve assembly 101 includes a valve body 103 and a bonnet 105. Bonnet 105 sealingly engages body 103 through interference fit and is configured to be selectively removed and re-coupled to body 103. When removed, access within body 103 is obtained. Body 103 is configured to pass fluid through a fluid channel 111. Fluid flow enters and exits through one of at least two separate openings. Body 103 includes a coupling end 107 and a threaded end 109 configured to receive any one of a number of tubes or devices for the transportation of fluid. Coupling end 107 and threaded end 109 act as separate openings for the passing of fluid. Fluid channel 111 extends between ends 107 and 109 internally within body 103 (see FIG. 5). Fluid channel 111 is a relatively cylindrical passage defining a channel axis 112.

It is understood that ends 107 and 109 are not limited to incorporating such couplings, threads, or any other types of attachment means as illustrated or described. Ends 107 and 109 may be configured to incorporate any method of attachment to permit valve assembly 101 to be in fluid communication with one or more corresponding tubes and/or devices to permit the passage of fluid through body 103.

Valve assembly 101 further includes an actuation member 113. Member 113 is configured to selectively receive user inputs and convey those user inputs in a manner so as to regulate the flow of fluid through fluid channel 111. For example, in the preferred embodiment, actuation member 113 acts as a handle that extends externally to body 103. The handle is configured to receive an applied torque from a user, thereby causing rotational movement in member 113 and corresponding movement within body 103 sufficient to regulate fluid flow.

Although illustrated as extending externally from body 103, it is understood that actuation member 113 may be at least partially external or internal to body 103. Additionally, although described as using mechanical methods to induce rotation, actuation member 113 may be configured to operate with at least one of a hydraulic, an electrical, or a pneumatic control system, to name a few. For example, a computerized device may be used to selectively convey user inputs to selectively regulate fluid flow.

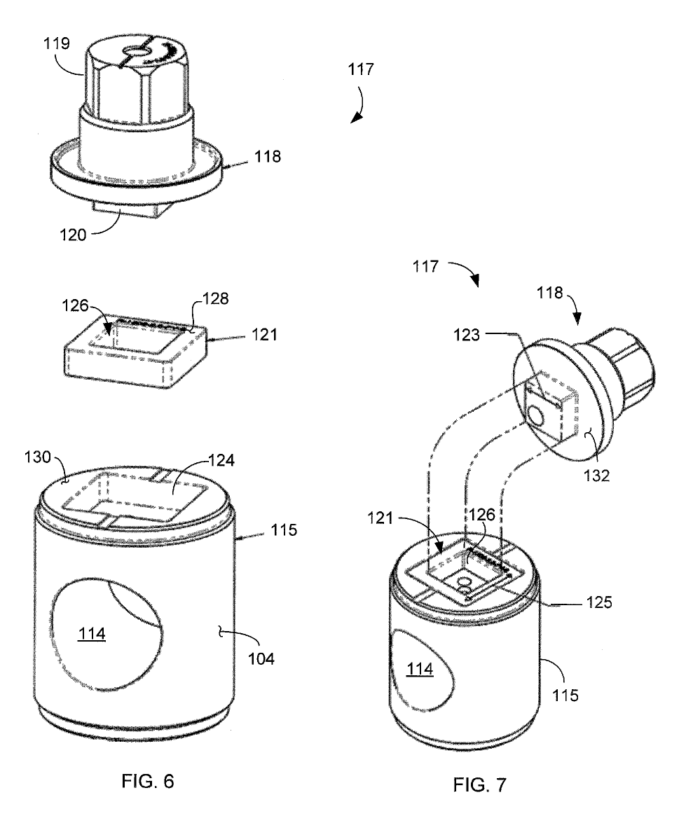

Referring now also to FIGS. 6 and 7 in the drawings, actuator stem assembly 117, a part of valve assembly 101, is illustrated. Actuator stem assembly 117 includes an actuator stem 118, an intermediate slider 121, and a plug 115. Stem assembly 117 is configured to permit bi-directional movement of the plug relative to actuator stem 118 to ensure a complete sealing engagement of plug 115 relative to body 103.

Plug 115 is configured to selectively regulate the flow of fluid within fluid channel 111. Plug 115 is located within body 103 and passes through fluid channel 111. The diameter of plug 115 is sized so as to be greater than that of the diameter of fluid channel 111. As seen in FIG. 5, plug 115 extends beyond the internal surfaces of fluid channel 111. Plug 115 includes a bore 114 that passes through plug 115 in coaxial alignment with fluid channel 111. Bore 114 defines a bore axis 116. Bore 114 permits fluid to pass beyond plug 115 between ends 107 and 109. Plug 115 maintains a cylindrical contour and is configured to rotate relative to body 103 about a plug axis 110. Plug axis 110 is perpendicular to channel axis 112. When plug 115 is in a first orientation (see FIG. 5) bore 114 is in coaxial alignment with fluid channel 111. In such an orientation, plug 115 causes no substantial restriction on the passage of fluid. However, as plug 115 is rotated 90 degrees, wherein bore axis 116 is now oriented perpendicularly to that of channel axis 112, outer walls 104 of plug 115 now extend across fluid channel 111. In the second orientation, the passage of fluid is restricted and prevented from passing between ends 107 and 109.

Plug 115 also includes a sealing member 122. Sealing members 122 extend along surface 104 of plug 115. Plug 115 is configured to sealingly engage body 103 in the second orientation and in any orientation there between the second orientation and the first orientation. Sealing members 122 assist in the sealing engagement of plug 115 and body 103.

As plug 115 rests within body 103, plug is exposed to forces exerted from the varying fluid pressure changes and flow rates. These forces can affect the alignment of plug 115 within body 103. Additionally, as the orientation of plug 115 is adjusted to regulate the fluid flow, subtle changes in alignment are also possible. Misalignment of plug 115 may cause a failure of plug 115 to sealingly engage body 103. External objects coupled to ends 107 and 109 may not be removed if plug 115 fails to seal. Realignment of plug 115 within body 103 is permitted by allowing for independent movement of stem 118 with respect to plug 115.

Stem 118 is axially aligned with plug 115 and is in communication with actuation member 113 so as to receive user inputs intended by a user to rotate plug 115. An upper portion 119 of stem 118 engages actuation member 113. A lower portion 120 extends externally from stem 118 and is configured to nestle within a recess 126 formed along an upper surface 128 of intermediate slider 121. Lower portion 120 is in sliding engagement with slider 121, so as to permit the relative translation of stem 118 with respect to slider 121. Translation of stem 118 occurs in first direction 123 as illustrated by arrows in FIG. 7. In this embodiment, stem 118 is not permitted to translate in other directions relative to slider 121. An example of an allowable degree of translation is that of 0.050 inches.

Slider 121 is configured to engage plug 115 within a recess 124 formed along an upper surface 130 of plug 115. Recess 124 is sized to permit slider 121 to translate relative to plug 115 along a second direction 125. In the preferred embodiment a 0.050 inch movement is permitted although design constraints may permit more or less movement. The depth of recess 124 is at least as deep as the thickness of slider 121 so as to enable surface 132 to contact and translate along surface 130 of plug 115. Contact between surfaces 130 and 132 help to stabilize stem 118 in receiving user inputs through actuation member 113. Directions 123 and 125 are aligned to be in cross-wise directions to one another, such that they are 90 degrees removed (perpendicular). The perpendicular alignment allows a bi-directional movement of stem 118 with respect to plug 115. Slider 121 allows stem 118 freedom of movement in two directions 123, and 125 while plug 115 is allowed freedom of movement at 90 degrees to stem 118.

Although a 0.050 inch movement is shown as an illustrated, it is understood that such a movement is for exemplary purposes. It is understood that the movement permitted in directions 123 and 125 exceeds the permitted tolerance of plug 115 in relation to sealing members in body 103. By maintaining movement in excess of the tolerance of plug 115, stem 118 is assured to move freely without binding or imposing external forces against plug 115 that may cause a misalignment.

If misaligned in body 103, plug 115 loses the ability to seal with sealing members. This is noticed especially at lower pressures since plug valves use the pressure to help them seal within body 103. Systems which fail to permit bi-directional movement are either unable to properly align or can only allow limited alignment when the plug has been turned a full 90 degrees to a closed position, resulting in a failure to seal.

The advantage of having bi-directional movement of stem 118 is that external forces acting upon stem 118 can be isolated from plug 115, thereby permitting only torsional forces to be applied to plug 115. Therefore, the alignment of plug 115 is not impaired.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified, and all such variations are considered within the scope and spirit of the invention. Accordingly, the protection sought herein is as set forth in the description. It is apparent that an invention with significant advantages has been described and illustrated. Although the present invention is shown in a limited number of forms, it is not limited to just these forms, but is amenable to various changes and modifications without departing from the spirit thereof.

What is claimed is:

1. A plug valve assembly, comprising:
a body having a fluid channel for the flow of fluid; and
an actuator stem assembly including:
a plug configured to rotate relative to the body, the plug located within the fluid channel, rotation of the plug regulates the flow of fluid;
an actuator stem in communication with the plug, the actuator stem configured to transfer a force to the plug so as to induce rotation of the plug; and
a slider located between the plug and the actuator stem, the slider being configured to permit bi-directional movement of the actuator stem relative to the plug;
wherein the bi-directional movement between the actuator stem and the plug permits realignment of the plug within the housing so as to maintain sealing engagement between the body and the plug.

2. The plug valve assembly of claim 1, wherein the plug has a central bore in selective alignment with a channel axis of the fluid channel

3. The plug valve assembly of claim 1, wherein the plug has a central bore configured to be coaxial with the fluid channel in a first orientation and perpendicular to the channel axis in a second orientation, the plug prevents that passage of fluid through the fluid channel in the second orientation.

4. The plug valve assembly of claim 1, wherein the plug has a plug axis perpendicular to a fluid channel axis, the plug being configured to rotate about the plug axis within the body, fluid flow within the fluid channel is regulated as the plug is rotated relative to the body.

5. The plug valve assembly of claim 1, wherein the slider is recessed within the plug, the slider being sized to permit translation between the slider and the plug in a first direction; and
wherein the actuator stem is nestled within a recess of the slider, the actuator stem being configured to translate within the recess in a second direction.

6. The plug valve assembly of claim 5, wherein the first direction is perpendicular to the second direction, thereby allowing bi-directional movement between the actuator stem and the plug.

7. The plug valve assembly of claim 1, further comprising:
a sealing member coupled to an outer surface of the plug, the sealing member is configured to prevent the passage of fluid around the outer surface.

8. The plug valve assembly of claim 1, further comprising:
an actuation member in communication with the actuator stem, the actuation member is configured to receive a user input so as to induce a rotational force.

9. The plug valve assembly of claim 8, wherein the actuation member is a handled protruding externally from the body.

10. The plug valve assembly of claim 8, wherein the actuation member transfers the user input through at least one of a hydraulic system, an electronic system, and a pneumatic system.

11. The plug valve assembly of claim 1, wherein external forces acting upon the actuator stem are isolated from the plug, thereby permitting only torsional forces to be applied to the plug and ensuring the sealing engagement.

12. An actuator valve assembly for use in a plug valve, the plug valve having a fluid channel, comprising:
an actuator stem at least partially located external to a body of the plug valve, the actuator stem configured to receive a user input directed to regulate fluid flow within the fluid channel;
a plug positioned below the actuator stem and located within the fluid channel, the plug having a bore coaxial with the fluid channel, the plug being configured to rotate within the fluid channel so as to selectively orient the bore perpendicular to the fluid channel; and
a slider located between the plug and the actuator stem, the slider being configured to permit bi-directional movement of the plug relative to the actuator stem, the bi-directional movement of the plug relative to the actuator stem permits realignment sealing engagement of the plug relative to the plug valve body.

13. The actuator valve assembly of claim 1, wherein the bi-directional movement isolates the plug from external forces acting upon the actuator stem, thereby permitting only torsional forces to be applied to the plug and ensuring the sealing engagement.

14. The actuator valve assembly of claim 12, wherein the user input induces a torsional force sufficient to rotate the plug about a plug axis, the plug rotating between a first orientation and a second orientation.

15. The plug valve assembly of claim 14, wherein the plug has a plug axis perpendicular to a fluid channel axis in the second orientation.

16. The plug valve assembly of claim 12, wherein the slider, the plug, and the actuator stem are in a stacked configuration wherein the slider is nestled within the plug beneath the actuator stem, the actuator stem permitted to translate in contact with an upper surface of the plug.

17. The plug valve assembly of claim 12, wherein the actuator stem translates relative to the slider along a first direction and the plug translates relative to the slider along a second direction, the first direction is perpendicular to the second direction, thereby allowing the bi-directional movement between the actuator stem and the plug.

18. The plug valve assembly of claim 12, further comprising:
a sealing member coupled to an outer surface of the plug, the sealing member is configured to prevent the passage of fluid around the outer surface of the plug.
